(19) United States
(12) Patent Application Publication
(10) Pub. No.: US 2010/0133436 A1
(43) Pub. Date: Jun. 3, 2010

(54) Infrared Power Control Supporting Multi-Use Functionality

(75) Inventor: Douglas K. Rosener, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/326,039

(22) Filed: Dec. 1, 2008

(51) Int. Cl. G01J 5/02; G01J 3/10

(52) U.S. Cl. 250/339.06; 250/504 R

(57) ABSTRACT

Systems and methods for infrared power control supporting multi-use functionality are presented. In one example, the transmit power level of an infrared (IR) light source on a headset having multiple functional states is controlled based on the headset function state. Infrared power control is used to determine proximity between an infrared source device and an infrared receiver device.

### BACKGROUND OF THE INVENTION

Infrared (IR) sources and receivers provide useful and low-cost wireless links between devices. Wireless infrared links may be useful wherever short range wireless communications are desired. For example, a common infrared device is a remote controller used to send commands to a display device or audio device, or to select a desired receiver device from among several potential receiver devices. Other common infrared devices include personal digital assistants and smartphones where the IR link is used for easy and quick data transmission.

As multi-function wireless devices proliferate, new applications for wireless IR links will arise. As a result, there is a need for improved methods and systems for infrared devices.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a multifunction infrared device in one example of the invention.

FIG. 2 illustrates an example discrete power control circuit for varying the infrared source transmit power level.

FIG. 3 illustrates an example continuous power control circuit for varying the infrared source transmit power level.

FIG. 4 illustrates a headset use application of the multifunction infrared device shown in FIG. 1.

FIG. 5 is a table illustrating varying the infrared source transmit power level of the infrared signal based on the current device function of a multifunction infrared device.

FIG. 6 illustrates a multifunction infrared device as shown in FIG. 1 having a unidirectional infrared link with a receiver device.

FIG. 7 illustrates a multifunction infrared device having both a unidirectional infrared link and a bi-directional radio frequency link with a receiver device.

FIG. 8 illustrates a multifunction infrared device having a bidirectional infrared link with a receiver device.

FIG. 9 illustrates determining the proximity between a multifunction infrared device and a receiver device in one example of the invention using the process illustrated in FIG. 11.

FIG. 10 illustrates determining the proximity between a multifunction infrared device and a receiver device in a further example of the invention, corresponding to the process illustrated in FIG. 12.

FIG. 11 is a flow diagram illustrating a process for determining proximity between a device 1 and a device 2 using a communication backchannel.

FIG. 12 is a flow diagram illustrating a process for determining proximity between a device 1 and a device 2 in a further example without using a communication backchannel.

FIG. 13 is a flow diagram illustrating a process for determining a near/far boundary power level in one example using a communication backchannel.

FIG. 14 is a flow diagram illustrating a process for selecting a desired IR receiver device from a plurality of receiver devices in one example using an IR source device having a variable power output level.

### DESCRIPTION OF SPECIFIC EMBODIMENTS

Methods and apparatuses for infrared power control supporting multi-use functionality are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Various aspects of this patent application have resulted from the Applicant's identification of unmet needs. For example, Applicant has identified that it would be useful to have a wireless infrared link serve as an out-of-band-link for simple pairing between two Bluetooth devices, providing a quick and secure pairing method. As a further example, Applicant has identified that it would be useful to determine whether a user is facing or not facing a display device based on whether an IR link is detected or not detected.

In the prior art, devices using infrared links typically utilize the link to perform only a single function, where the transmit power level of the infrared light source is at a fixed level to implement the single function. Applicant has further identified that it would be useful to have infrared devices that are capable of performing multiple functions using an infrared link. For example, since headsets are easily worn or carried, it would be useful to have a headset performing several infrared related functions. It would also be useful in a variety of applications to determine the proximity of the infrared link devices to each other.

In one example, the transmit power level of an infrared (IR) light source on a headset having multiple functional states is controlled based on the headset function state. In one example, the transmit power level is cycled to determine the proximity between the headset and a receiver device such as a base station. Use of IR power control based on headset function allows the headset's IR subsystem to be used for multiple purposes, such as device simple pairing, facing/no facing presence detection, near/far determination, and remote control. Use of IR power control can also improve device performance for individual functions, such as improved performance in simple pairing and remote control. Furthermore, use of IR power control also enables new methods for determining near/far status.

In one example, an IR device includes an IR light source to output an IR signal, a power control means for controlling an IR signal power level of the IR signal, a processor, and a computer readable memory. The computer readable memory stores a first set of instructions that when executed by the processor cause the multi-function IR device to enter a first device function state and stores a second set of instructions that when executed by the processor cause the multi-function IR device to enter a second device function state, where the IR signal power level is adjusted responsive to whether the multi-function IR device is in the first device function state or the second device function state.

In one example, a method for determining proximity between an IR source device and an IR receiver device includes cycling a power level of an IR signal transmitted from an IR source device to an IR receiver device. The method includes receiving a notification from the IR receiver device that detection of the IR signal at the receiver device has been lost, and identifying a lost detection power level at which detection of the IR signal at the receiver device was lost. The method further includes determining a proximity between the IR source device and the IR receiver device utilizing the lost detection power level.

In one example, a method for determining proximity between an IR source device and an IR receiver device includes receiving a series of IR signals at an IR receiver device transmitted from an IR source device, each successive IR signal of the series of IR signals transmitted from the IR source device having a decreasing power level from a prior IR signal. Each IR signal includes associated transmit power level data. The method further includes identifying at the IR receiver device when detection of the series of IR signals is lost, and decoding at the IR receiver device the associated transmit power level of the prior IR signal received. The method further includes determining a proximity between the IR source device and the IR receiver device utilizing the associated transmit power level of the prior IR signal received.

In one example, a method for operating a multi-function IR light output device includes providing a multi-function IR light output device having two or more user selectable operating function states, and receiving at the multifunction IR light output device a user selected operating function state. The method further includes selectively adjusting a power level of an IR light source output responsive to the user selected operating function state.

In one example, a method for selecting a desired IR receiver from among several potential IR receivers includes outputting a first IR function request signal from an IR source device, and receiving notification from two or more IR receivers that the IR function request signal was detected by the two or more IR receivers. The method further includes outputting a second IR function request signal from the source device having a selectively decreased power level from the first IR function request signal, and receiving notification from a single IR receiver that the second IR function request signal was detected by the single IR receiver.

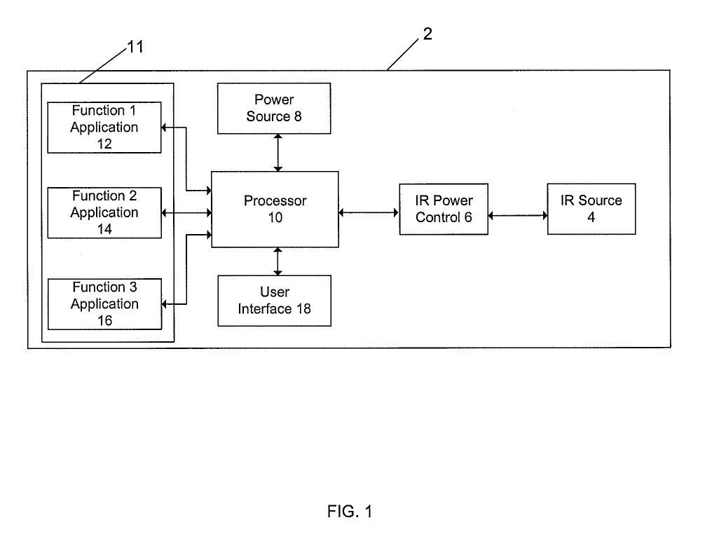

FIG. 1 illustrates a multifunction IR device 2 in one example of the invention. The multifunction IR device 2 includes an IR source 4, IR power control 6, processor 10, power source 8, user-interface 18, and computer-readable memory 11. Residing in memory 11 is a function 1 application 12, function 2 application 14, and function 3 application 16. For example, computer readable memory 11 may be a RAM device or ROM device. Alternatively, function 1 application 12, function 2 application 14, and function 3 application 16 may reside on any other computer readable storage media that can store data readable by a computer system. Examples of computer readable storage media include hard disks, optical media, and specially configured hardware devices such as application-specific integrated circuits (ASICs) and programmable logic devices (PLDs).

In one example, IR source 4 is a light emitting diode used to output an IR signal. Infrared power control 6 in communication with processor 10 controls the power level of the IR signal. In further examples, multifunction IR device 2 may also include a radio frequency transceiver or an IR light signal detector. The IR source 4 can be optionally modulated by a data stream from the processor 10. The data stream can be used to transmit, for example, data identifying the source, data describing the functionality desired by the signal, and the IR source power level.

When executed by processor 10, function 1 application 12, function 2 application 14, and function 3 application 16 cause the multifunction IR device 2 to enter a function 1 device state, function 2 device state, and function 3 device state, respectively. The power level of the IR signal is adjusted responsive to whether the multifunction IR device 2 is in a function 1 device state, function 2 device state, or function 3 device state. In one example, a user selects the device operating state using user-interface 18. Although illustrated as having three function applications, one of ordinary skill in the art will recognize that the multifunction IR device 2 may have fewer or a greater number of device functions for which the power level of the output IR signal is adjusted.

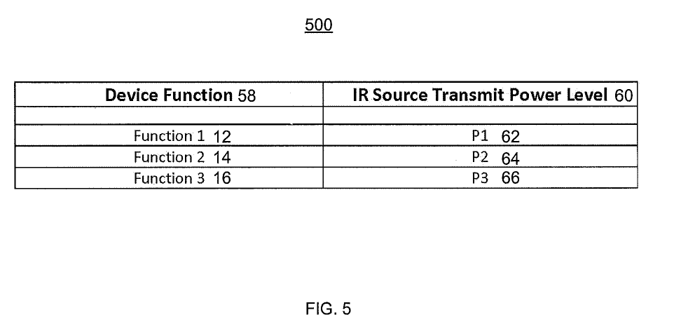

FIG. 5 is a table 500 illustrating varying the IR source transmit power level 60 of the IR signal based on a current device function 58 of multifunction IR device 2. When the multifunction IR device 2 is operated using function 1 application 12, the IR source transmit power level 60 is at a power level P1 62. When the multifunction IR device 2 is operated using function 2 application 14, the IR source transmit power level 60 is at a power level P2 64. When the multifunction IR device 2 is operated using function 3 application 16, the IR source transmit power level 60 is at a power level P3 66. The IR source transmit power level 60 for each device function 58 may be a single or range of power levels.

The multifunction IR device 2 device states may vary. For example, the device states may include a pairing state, a receiver device selection state, a facing/no facing presence detection state, and a remote function control state. In a remote function control state (i.e., when operated as a remote controller), data is communicated via the IR link. At a minimum, the data communicated is the function to be executed. Generally, remote function control is desired to be done at a distance, often as far away as possible from the receiver, thus requiring a higher or maximum IR source transmit power level.

In a pairing state, the devices to be paired are placed in close proximity. This allows the user to indicate the desire to pair specific devices without having to select from a list, thereby simplifying the task of pairing. Since pairing is done at close proximity, a lower IR source transmit power level is required.

In a receiver device selection state, the multifunction IR device is used to select a desired receiver from among several potential receivers. Selection of a desired receiver requires the user also bring the multifunction IR device within close proximity to the desired receiver so that undesired receiver devices do not detect an IR transmission. Since receiver device selection is done at close proximity, a lower IR source transmit power level is possible, further enhancing selection of the device by reducing the chances of another device picking up the IR transmissions.

In a facing/no facing presence detection state, the IR signal is used to determine whether the wearer of the multifunction IR device is facing a particular object, such as his or her computer monitor. Facing status is a useful input for unified communications presence applications. Establishment of an IR link indicates the person is facing the object of interest, and the IR signal is typically made directional for this purpose. Further discussion of facing/no facing and presence detection can be found in pending U.S. patent application Ser. No. 12/211,701 filed Sep. 16, 2008, entitled “Infrared Derived User Presence and Associated Remote Control”, assigned to the present Applicant Plantronics Inc., the full disclosure of which is hereby incorporated by reference for all purposes. In facing/no facing presence detection applications, the user is typically anywhere from 1 to 10 feet or more away from the receiver device (typically a base station in headset presence applications). Generally, to achieve the farther distances a mid-range IR source transmit power level is used, as facing is not a useful indication when the user is extremely far away from the receiver device. Furthermore, by allowing the user to adjust the IR power level to the minimum necessary for their environment, false facing-detection which might occur at a more distant user position from the base can be reduced.

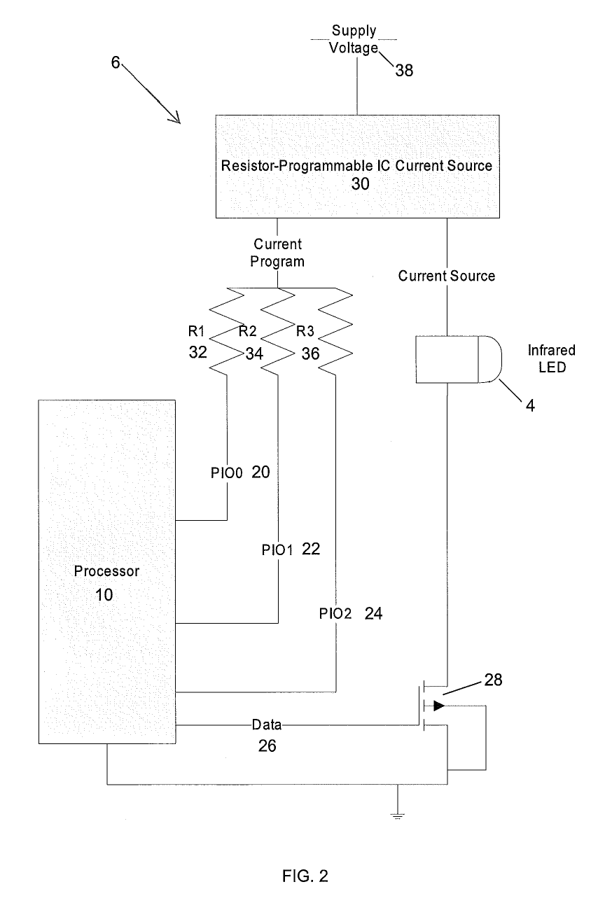

The power control of the IR source may be discrete or continuous. One of ordinary skill in the art will recognize that a variety of power control circuits may be used to control the IR source transmit power level. FIG. 2 illustrates an example discrete power control circuit 6 for varying the IR source transmit power level. Power control circuit 6 includes a resistor programmable IC current source 30 driving IR source 4. Resistor programmable IC current source 30 is coupled to a supply voltage 38. Processor 10 includes a programmable input/output PIO0 20 coupled to a resistor R1 32, programmable input/output PIO1 22 coupled to a resistor R2 34, and programmable input/output PIO2 24 coupled to a resistor R3 36. Resistor R1 32, Resistor R2 34, and resistor R3 36 are shunt resistors switched in and out of the circuit 6 by processor 10 using PIO0 20, PIO1 22, and PIO2 24. Switching of the shunt resistors determines the current level of the resistor programmable IC current source 30 driving the IR source 4, and thereby the IR source transmit power level. Various combinations of resistor R1 32, resistor R2 34, and resistor R3 36 may be used. A field effect transistor (FET) 28 may be used to switch IR source 4 on and off, where the FET 28 is controlled by processor 10 via a data line 26.

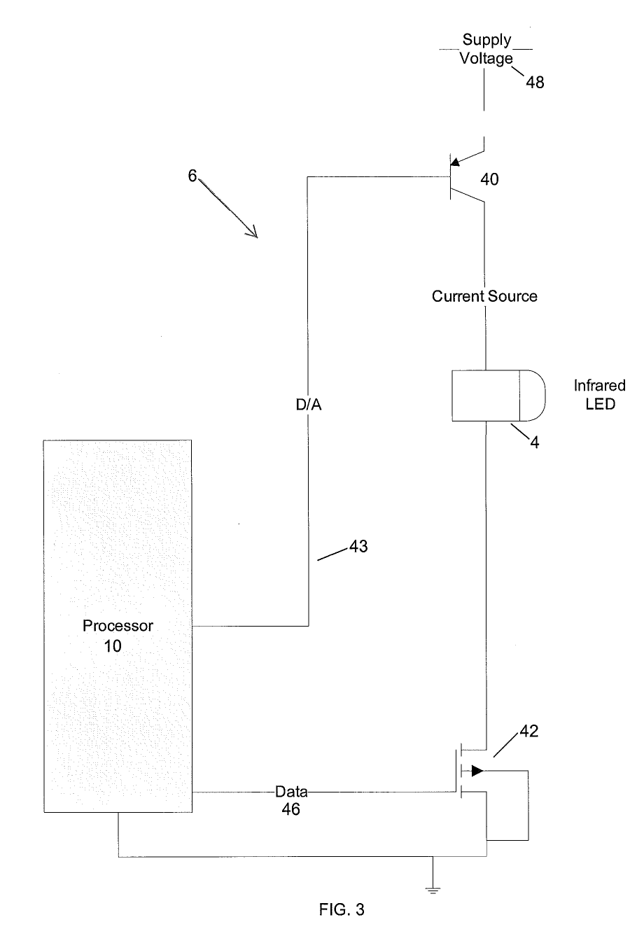

FIG. 3 illustrates an example of a continuous power control circuit 6 for varying the IR source transmit power level. Power control circuit 6 includes a transistor current source 40 driving IR source 4. Transistor current source 40 is coupled to a supply voltage 48. Processor 10 includes a data output 43 coupled to a D/A converter within processor 10, such that data output 43 is an analog control signal used to control the current level of the transistor current source 40 driving the IR source 4, and thereby the IR source transmit power level. In a further example, a D/A converter external to processor 10 is utilized to convert a digital data output from processor 10 to the analog control signal used to control the current level of the transistor current source 40. A field effect transistor (FET) 42 may be used to switch IR source 4 on and off, where the FET 42 is controlled by processor 10 via a data line 46.

In one example, a multifunction IR device 2 includes a head mounted device housing such as a headset or ear-piece in which the IR source 4 is oriented to emit the IR signal in a desired direction. The multifunction IR device 2 may also include additional IR light sources oriented in the head mounted device housing to emit additional IR signals in different desired directions. In one example, four IR light sources are used and oriented within the head mounted device housing to emit IR signals in directions 90 degrees apart. This could be useful for determining the user orientation based on the which source (each with unique coded data) was detected.

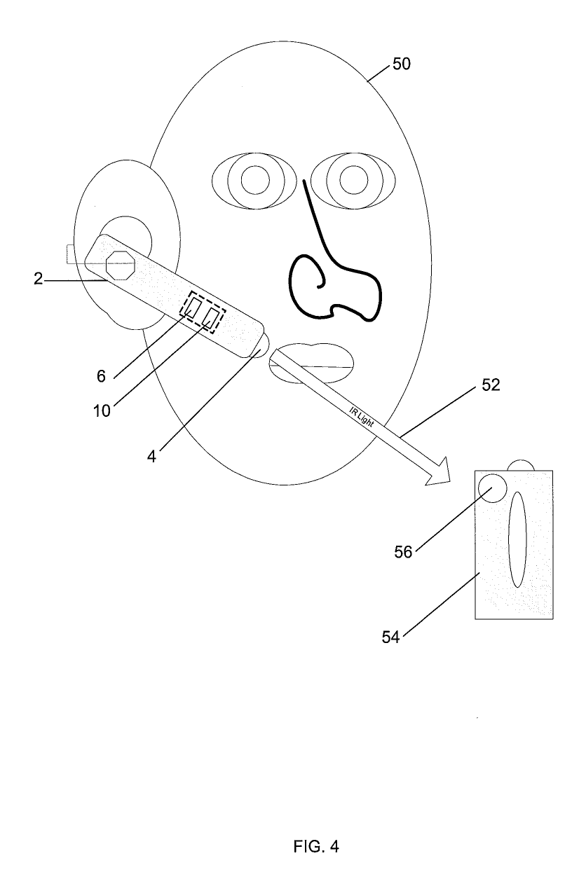

FIG. 4 illustrates a headset use application of multifunction IR device 2. A user 50 wearing a multifunction IR device 2 in the form of the headset transmits an IR light signal 52 which is received at an IR receiver device 54 having a photodetector 56. The IR receiver device 54 in this example may be a headset base. In an example where multifunction IR device 2 includes multiple IR light sources, the IR light sources may be oriented so that IR light signals are emitted in a direction forward of the user 50, behind the user 50, and to the side of user 50.

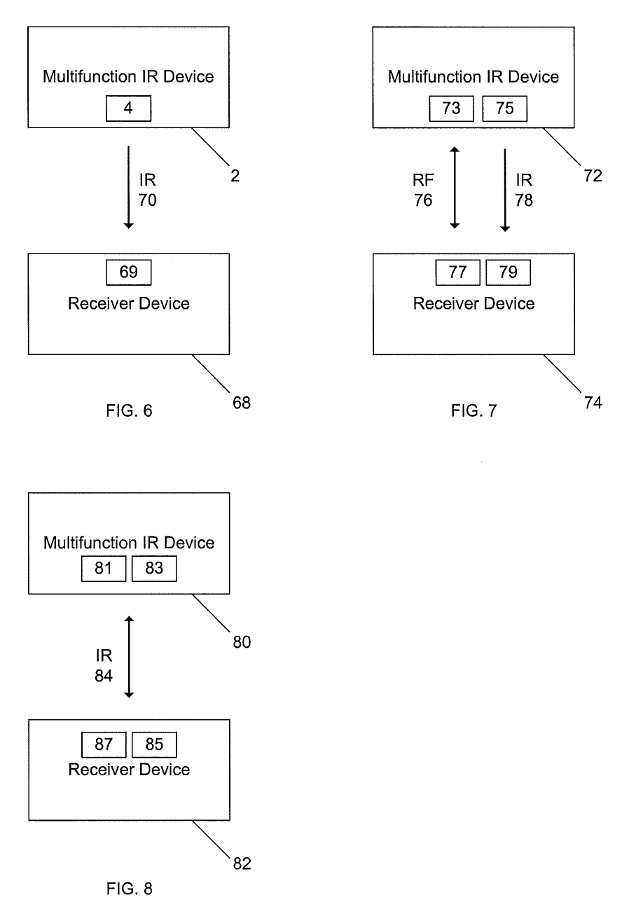

FIGS. 6 to 8 illustrate examples of multifunction IR devices having various wireless communications means. FIG. 6 illustrates a multifunction IR device 2 as shown in FIG. 1 having an IR source 4 forming a unidirectional IR link 70 with a receiver device 68. Receiver device 68 includes a corresponding IR light detector 69. In one example, multifunction IR device 2 is a wireless headset and receiver device 68 is a headset base station. In a further example, multifunction IR device 2 is a headset base station, and receiver device 68 is a wireless headset.

FIG. 7 illustrates a multifunction IR device 72 having both a unidirectional IR link 78 and a bi-directional radio frequency link 76 with a receiver device 74. Multifunction IR device 72 is similar to multifunction IR device 2 shown in FIG. 1, with the exception that it also includes a radio frequency transceiver 73 in addition to an IR light source 75. The receiver device 74 includes a corresponding radio frequency transceiver 77 and IR light source detector 79. Bi-directional radio frequency link 76 provides a backchannel data path in a direction opposite to IR link 78.

FIG. 8 illustrates a multifunction IR device 80 having a bidirectional IR link 84 with a receiver device 82. Multifunction IR device 80 is similar to multifunction IR device 2 shown in FIG. 1, with the exception that it also includes an IR light detector 81 in addition to an IR light source 83. Receiver device 82 includes a corresponding IR light source 87 and IR light detector 85.

FIG. 11 is a flow diagram illustrating a process for determining proximity between a device 1 and a device 2 where a communication back channel exists. For example, the device 1 may be the multifunction IR device 72 shown in FIG. 7 or the multifunction IR device 80 shown in FIG. 8. The device 2 may be the receiver device 74 or receiver device 82, respectively, as shown in FIG. 7 and FIG. 8. In a further example, device 1 and device 2 need not be multifunction IR devices or receivers to perform the processes described herein. For example, device 1 is any IR device capable of outputting an IR light signal at an adjustable power level P.

At block 1102, an IR light signal at a power level P is sent from device 1 to device 2. At decision block 1104, it is determined whether the IR light signal was detected at device 2. If “yes” at decision block 1104, at block 1106 the power level P is decreased by an increment. Following block 1106, the process returns to block 1102. In this manner, the power level P is cycled. If “no” at decision block 1104, at block 1108 notification is received at device 1 from device 2 that IR light signal detection has been lost. If device 1 is the multifunction IR device 72 shown in FIG. 7, the notification is received at a radio frequency transceiver 73 over radiofrequency link 76. If device 1 is the multifunction IR device 80 shown in FIG. 8, the notification is received at IR light detector 81 over bidirectional IR link 84.

At block 1110 the power level P of the IR light signal at which IR light signal detection was lost is identified. At block 1112 the proximity between device 1 and device 2 is determined utilizing the identified power level P at which signal detection was lost.

In one example, determining the proximity between device 1 and device 2 involves determining whether device 1 is in a near status or a far status with respect to device 2. Near status and far status are further discussed, for example, in pending U.S. patent application Ser. No. 12/211,701 filed Sep. 16, 2008, entitled “Infrared Derived User Presence and Associated Remote Control”, the disclosure having been incorporated by reference above. In one example, near status or far status is determined by comparing the lost detection power level to a pre-determined near/far boundary power level. In further examples, determining proximity may involve calculating a distance between device 1 and device 2 or other relative proximity.

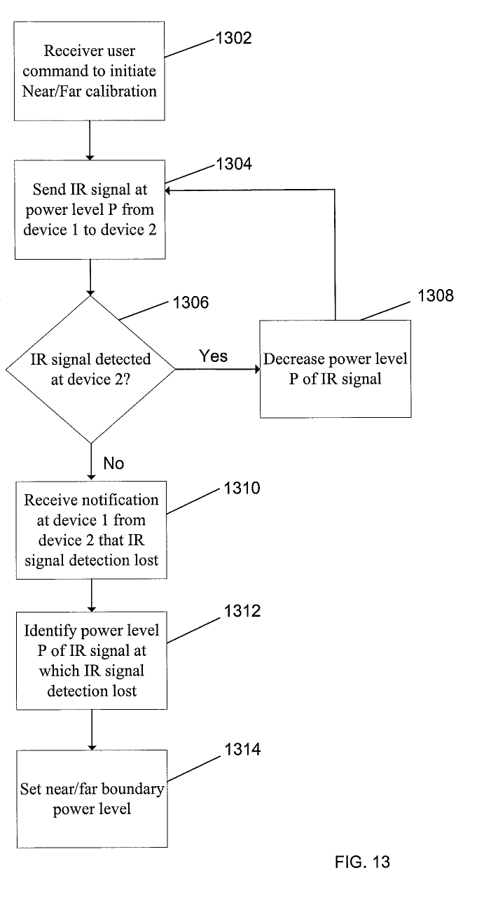

FIG. 13 is a flow diagram illustrating a process for determining a near/far boundary power level in one example without using a communication backchannel. At block 1302, a user command is received at device 1 to initiate near/far calibration. Prior to initiating this command, the user positions the device 1 at a proximity from device 2 corresponding to the user desired near/far boundary point, closer which is deemed near status and further which is deemed far status. At block 1304, an IR light signal at a power level P is sent from device 1 to device 2.

At decision block 1306, it is determined whether the IR light signal was detected at device 2. If “yes” at decision block 1306, at block 1308 the power level P is decreased by an increment. Following block 1308, the process returns to block 1304. In this manner, the power level P is cycled. If “no” at decision block 1306, at block 1310 notification is received at device 1 from device 2 that IR light signal detection has been lost. If device 1 is the multifunction IR device 72 shown in FIG. 7, the notification is received at a radio frequency transceiver 73 over radiofrequency link 76. If device one is the multifunction IR device 80 shown in FIG. 8, the notification is received at IR light detector 81 over bidirectional IR link 84.

At block 1312 the power level P of the IR light signal at which IR light signal detection was lost is identified. At block 1314, the near/far boundary power level is set using the identified lost to detection power level. In a further example, an initial near/far boundary power level is pre-determined and set by the device manufacturer.

The method described in FIG. 13 can also be used for setting the power level to be used in the FACE/NOFACE function. Again the user selects the desired proximity where FACE state should be considered (and minimizes reflections) and proceeds as described in FIG. 13 to set the FACE/NOFACE function power level.

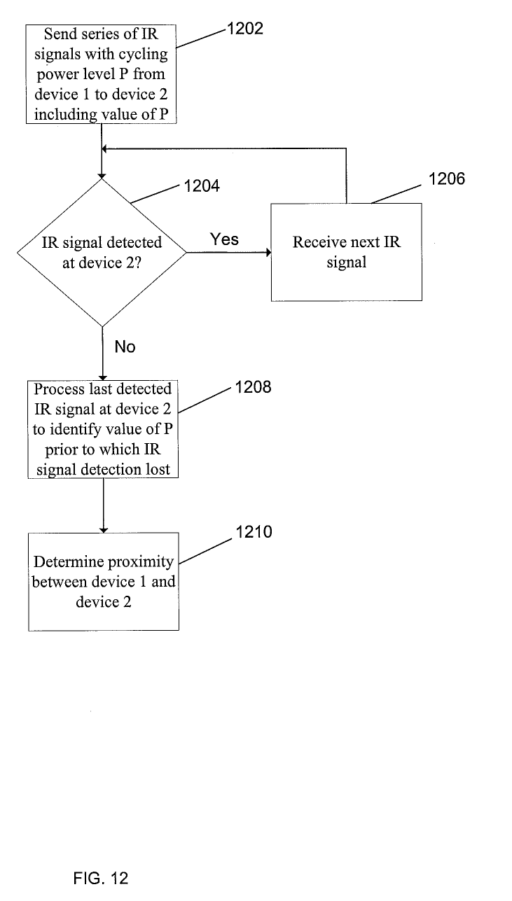

FIG. 12 is a flow diagram illustrating a process for determining proximity between a device 1 and a device 2 in a further example without using a communication backchannel. For example, the device 1 may be the multifunction IR device 2 and the device 2 may be the receiver device 68 shown in FIG. 6. In further examples, device 1 need not be a multifunction IR device. For example, device 1 is any IR device capable of outputting an IR light signal at an adjustable power level P. Alternatively the configurations shown in FIG. 7 and FIG. 8 may be used.

At block 1202, a series of IR light signals with a cycling power level P are sent from device 1 to device 2, where each IR light signal sent includes encoded data corresponding to the value of the power level P at which the IR light signal is sent. Each successive IR light signal of this series is sent with an incrementally decreasing power level P. At decision block 1204, it is determined whether the IR light signal has been detected at device 2. If “yes” at decision block 1204, at block 1206 the next IR light signal is received at device 2 and the process returns to decision block 1204. If “no” at decision block 1204, at block 1208 the last detected IR light signal is processed to identify the value of power level P prior to which IR signal detection was lost. For example, the IR light signal is decoded to identify the power level P. At block 1210 the proximity between device 1 and device 2 is determined utilizing the identified transmit power level of the last detected IR light signal at block 1208. In a further example, each successive IR light signal of this series is sent with an incrementally increasing power level P and the value of the power level P of the first detected IR signal is identified.

In one example, determining the proximity between device 1 and device 2 involves determining whether device 1 is in a near status or a far status with respect to device 2. In one example, near status or far status is determined by comparing the lost detection power level to a pre-determined near/far boundary power level. In one example, the near/far boundary power level is determined without using a communication backchannel by performing the process illustrated in FIG. 12 following placement of device 1 at a proximity from device 2 corresponding to a user defined near/far boundary. The power level where the last detection occurred can then be used by the receiver device as the near/far boundary power level.

In one example the IR light signal transmitted from device 1 to device 2 includes a source identifier to distinguish the IR source from other IR sources at device 1. The source identifier is decoded from the IR light signal received at device 2. Where each IR light source at device 1 is associated with a particular user orientation, the decoded source identifier may be used to identify a current user physical orientation with respect to device 2.

In one example, device 2 includes a plurality of IR photodetectors disposed at different orientations within the device housing. For example, four photodetectors may be disposed 90° apart. Where each photodetector at device 2 is associated with a particular user orientation, the photodetector at which an IR light signal is received may be used to identify a current user physical orientation (i.e., device 1 orientation). In one example, device 2 is a head mounted device with a plurality of photodetectors or a base station with a plurality of photodetectors.

In addition to providing information used to identify a current user physical orientation, multiple IR light sources at device 1 or multiple photodetectors at device 2 may assist in determining a more accurate near/far state. Where only a single IR light source and photodetector is used, a person not facing may undesirably provide a false near/far state due to a premature loss of signal while measurement is occurring or as a reflected detection causing a reduction in received power level. However, the potential for a false far state can be reduced by using multiple sources or receivers. In this way, a direct line of sight is more likely to be maintained so that as the power is lowered, a reflected reception will drop out at a higher power level than the power level for the direct line of site, thereby ensuring the direct line of sight is used for the near/far determination.

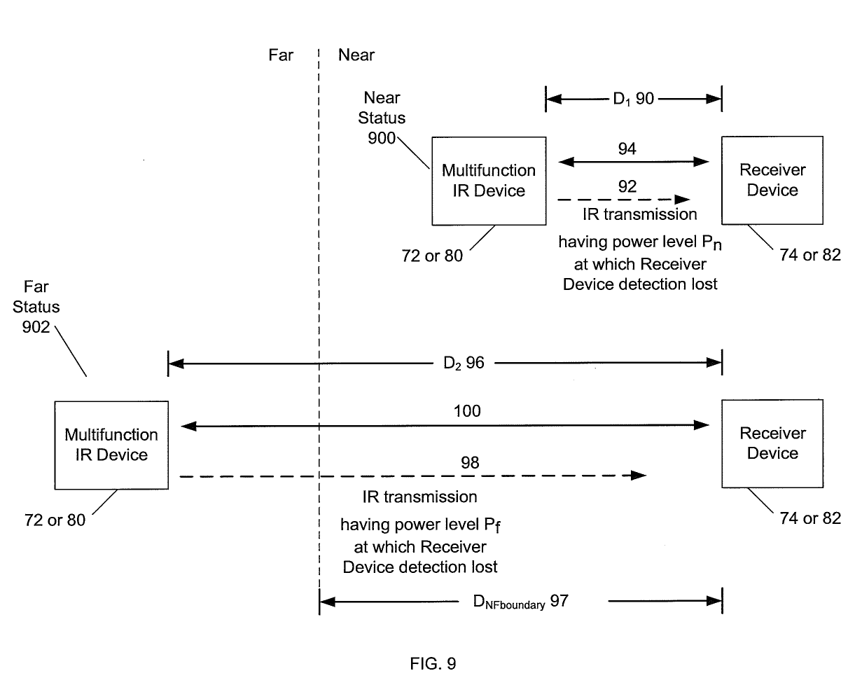

FIG. 9 illustrates determining the proximity between a multifunction IR device and a receiver device in two usage states in one example of the invention using the process illustrated in FIG. 11. As described previously, the IR devices need not be multifunction devices in further examples in order to perform the described processes. FIG. 9 illustrates a multifunction IR device 72 or 80 in two usage states: a near status 900 and a far status 902. In near status 900, multifunction IR device 72 or 80 is a distance D₁ 90 from a receiver device 74 or 82, where distance D₁ 90 is less than a distance D_{nfboundary} 97, where distance D_{nfboundary} 97 is the boundary between near status and far status. In far status 902, multifunction IR device 72 or 80 is a distance D₂ 96 from a receiver device 74 or 82, where distance D₂ 96 is greater than the distance D_{nfboundary} 97.

To determine the near status 900 usage state, an IR light signal 92 having a power level PN at which receiver device 74 or 82 loses detection is sent from multifunction IR device 72 or 80 to receiver device 74 or 82. Upon loss of IR light signal detection, receiver device 74 or 82 transmits a lost IR signal detection notification 94 to multifunction IR device 72 or 80. Where multifunction IR device 72 is used, lost IR signal detection notification 94 is transmitted over a radiofrequency link. Where multifunction IR device 80 is used, lost IR signal detection notification 94 is transmitted over an IR link. The power level P_{N} is identified at multifunction IR device 72 or 80 and compared to a pre-determined near far boundary power level P_{NFboundary} to determine near status 900. In near status 900, power level P_{N} is less than the pre-determined near far boundary power level P_{NFboundary}.

To determine the far status 902 usage state, an IR light signal 98 having a power level P_{F} at which receiver device 74 or 82 loses detection is sent from multifunction IR device 72 or 80 to receiver device 74 or 82. Upon loss of IR light signal detection, receiver device 74 or 82 transmits a lost IR signal detection notification 100 to multifunction IR device 72 or 80. Where multifunction IR device 72 is used, lost IR signal detection notification 100 is transmitted over a radiofrequency link. Where multifunction IR device 80 is used, lost IR signal detection notification 100 is transmitted over an IR link. The power level P_{F} is identified at multifunction IR device 72 or 80 and compared to a pre-determined near far boundary power level P_{NFboundary} to determine far status 902. In far status 902, power level P_{F} is less than the pre-determined near far boundary power level P_{NFboundary}.

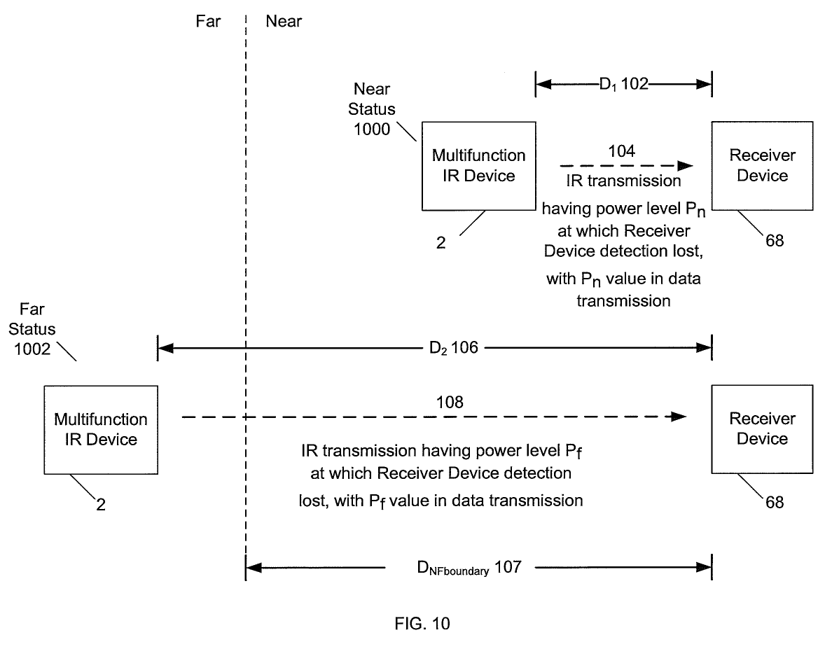

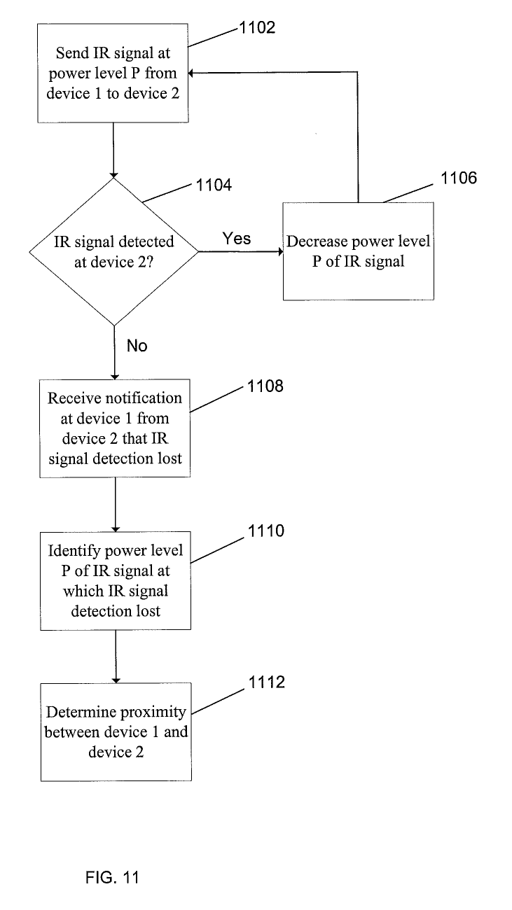

FIG. 10 illustrates determining the proximity between a multifunction IR device and a receiver device in two usage states in a further example of the invention, corresponding to the process illustrated in FIG. 12. As described previously, the IR devices need not be multifunction devices in further examples in order to perform the described processes. FIG. 10 illustrates a multifunction IR device 2 in two usage states: a near status 1000 and a far status 1002. In near status 1000, multifunction IR device 2 is a distance D₁ 102 from a receiver device 68, where distance D₁ 102 is less than a distance D_{nfboundary} 107, where distance D_{nfboundary} 107 is the boundary between near status and far status. In far status 1002, multifunction IR device 2 is a distance D₂ 106 from a receiver device 68, where distance D₂ 106 is greater than the distance D_{nfboundary} 107.

To determine the near status 1000 usage state, an IR light signal 104 having a power level P_{N} at which receiver device 68 loses detection is sent from multifunction IR device 2 to receiver device 68. IR light signal 104 includes the value of power level P_{N} encoded as data. Upon loss of IR light signal detection, receiver device 68 processes the last received IR light signal 104 to decode the value of power level Pₗₐₛₜ encoded in the last received IR light signal 104. The power level Pₗₐₛₜ is compared to a pre-determined near far boundary power level to determine near status 1000. In near status 1000, power level Pₗₐₛₜ is less than the pre-determined near far boundary power level.

To determine the far status 1002 usage state, an IR light signal 108 having a power level P_{F} at which receiver device 68 loses detection is sent from multifunction IR device 2 to receiver device 68. IR light signal 108 includes the value of power level P_{F} encoded as data. Upon loss of IR light signal detection, receiver device 68 processes the last received IR light signal 104 to decode the value of power level Pₗₐₛₜ encoded in the last received IR light signal 104. The power level Pₗₐₛₜ is compared to a pre-determined near far boundary power level to determine far status 1002. In far status 1002, power level Pₗₐₛₜ is greater than the pre-determined near far boundary power level.

Referring again to FIG. 10 and FIG. 11, although only a near status usage state and a far status usage state are described, in further examples, additional usage states may be utilized. For example, a very far status usage state, very near status usage, and indeterminate usage state may be utilized. A lookup table setting forth corresponding power levels for each usage state may be used to identify the usage state for a given power level P_{F} or power level Pₗₐₛₜ. Furthermore, hysteresis methods known in the art may be utilized at the boundaries between each usage to state to prevent rapid toggling between usage states.

As described earlier, in a receiver device selection state, the multifunction IR device is used to select a desired receiver from among several potential receivers. Selection of a desired receiver requires the user also bring the multifunction IR device within close proximity to the desired receiver so that undesired receiver devices do not detect an IR transmission. Since receiver device selection is done at close proximity, a lower IR source transmit power level is possible, further enhancing selection of the device by reducing the chances of another device picking up the IR transmissions. However, in certain instances, multiple receivers may still detect the IR transmission. In one example solution to this scenario, the IR source transmit power level of an IR device is lowered and the IR device brought closer to a desired device until the correct device is selected. The IR device may be a multifunction IR device as described, or may be any IR device capable of outputting an IR light signal at an adjustable power level P.

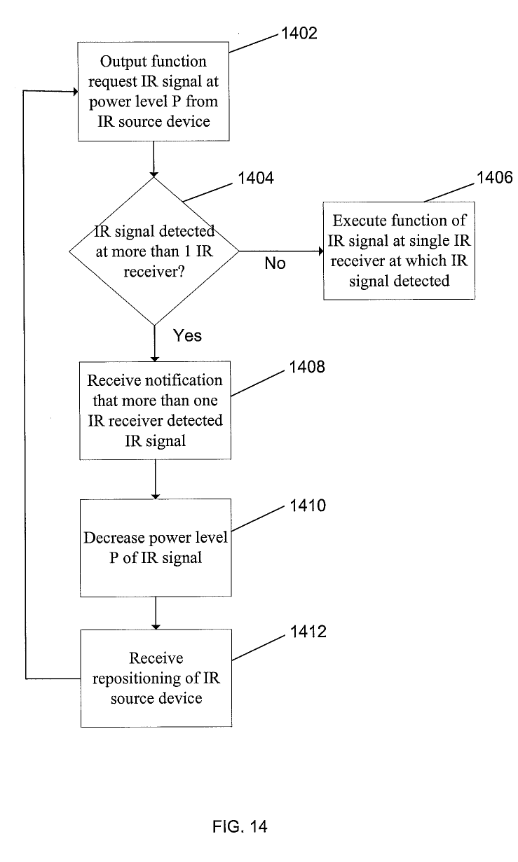

FIG. 14 is a flow diagram illustrating a process for selecting a desired IR receiver device from a plurality of receiver devices using an IR source device having a variable power output level. At block 1402, a function request IR signal at a power level P is output from an IR source device. At decision block 1404, it is determined whether the function request IR signal has been detected by more than one IR receiver device. If “no” at decision block 1404, then at block 1406 the single receiver device which received the function request IR signal executes the function request. If “yes” at decision block 1404, at block 1408 notification is received that more than one IR receiver device detected the function request IR signal.

For example, notification may be received at the IR source device via a communication backchannel from the IR receiver devices to the IR source device. This communication backchannel may be an IR channel or a RF channel. Alternatively, each receiver device may indicate via an output user interface indicator that it received the function request IR signal, where the user of the IR source device views the indicator. For example, the output user interface indicator may be a LED or display on the IR receiver devices. At block 1410, the power level P of the next function request IR signal is decreased. For example, the power level P may be decreased automatically by the IR source device or manually by the IR source device user. At block 1412, a repositioning of the IR source device is received. For example, the user may walk towards the desired IR receiver. Following block 1412, the process returns to block 1402.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: the number and type of functions performed by the multi-function IR device; the values of the transmit power level of the IR source for each function performed by the multi-function IR device; the methods for controlling the transmit power level of the IR source. Furthermore, the functionality associated with any blocks described above may be centralized or distributed. It is also understood that one or more blocks of the headset may be performed by hardware, firmware or software, or some combinations thereof. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1 An infrared (IR) device comprising:
an IR light source to output an IR signal;
a power control means for controlling an IR signal power level of the IR signal;
a processor;
a computer readable memory storing a first set of instructions that when executed by the processor cause the multi-function infrared device to enter a first device function state and storing a second set of instructions that when executed by the processor cause the multi-function infrared device to enter a second device function state, wherein the IR signal power level is adjusted responsive to whether the multi-function infrared device is in the first device function state or the second device function state.

2. The infrared device of claim 1, wherein the IR light source is a light emitting diode.

3. The infrared device of claim 1, wherein the first device function state and the second device function state are each selected from one of the following group: a pairing state, a receiver device selection state, a facing/no facing presence detection state, and a remote function control state.

4. The infrared device of claim 1, further comprising a radiofrequency (RF) transceiver or IR light detector.

5. The infrared device of claim 1, further comprising a head mounted housing in which the IR light source is oriented to emit the IR signal in a desired first direction.

6. The infrared device of claim 5, further comprising a second IR light source oriented in the head mounted housing to emit a second IR signal in a desired second direction different from the desired first direction.

7. The infrared device of claim 6, wherein the first direction and second direction are 90 degrees apart or 180 degrees apart.

8. A method for determining proximity between an IR source device and an IR receiver device comprising:
cycling a power level of an IR signal transmitted from an IR source device to an IR receiver device;
receiving a notification from the IR receiver device that detection of the IR signal at the receiver device has been lost;
identifying a lost detection power level at which detection of the IR signal at the IR receiver device was lost;
determining a proximity between the IR source device and the IR receiver device utilizing the lost detection power level.

9. The method of claim 8, wherein determining a proximity between the IR source device and the IR receiver device utilizing the lost detection power level comprises determining a near status or a far status.

10. The method of claim 9, wherein determining a near status or a far status comprises comparing the lost detection power level to a pre-determined near/far boundary power level.

11. The method of claim 8, wherein receiving a notification from the IR receiver device that detection of the IR signal at the receiver device has been lost comprises receiving an RF signal or a IR receiver device transmitted IR signal.

12. A method for determining proximity between an IR source device and an IR receiver device comprising:
receiving a series of IR signals at an IR receiver device transmitted from an IR source device, each successive IR signal of the series of IR signals transmitted from the IR source device having a decreasing power level from a prior IR signal, wherein each IR signal includes associated transmit power level data;
identifying at the IR receiver device when detection of the series of IR signals is lost;
decoding at the IR receiver device the associated transmit power level of the prior IR signal received; and
determining a proximity between the IR source device and the IR receiver device utilizing the associated transmit power level of the prior IR signal received.

13. The method of claim 12, wherein determining a proximity between the IR source device and the IR receiver device utilizing the associated transmit power level of the prior IR signal received comprises determining a near status or a far status.

14. The method of claim 13, wherein determining a near status or a far status comprises comparing the associated transmit power level of the prior IR signal received to a pre-determined near/far boundary power level.

15. The method of claim 12, wherein each IR signal further includes an IR light source identifier, the method further comprising:
decoding at the IR receiver device the IR light source identifier.

16. The method of claim 15, further comprising identifying a current user physical orientation utilizing the IR light source identifier.

17. The method of claim 12, wherein receiving a series of IR signals at an IR receiver device transmitted from an IR source device comprises receiving the series of IR signals at one of a plurality of photodetectors disposed at different orientations at the IR receiver device.

18. The method of claim 17, further comprising identifying a current user physical orientation utilizing an identity of the one of the plurality of photodetectors at which the series of IR signals are received.

19. A method for operating a multi-function IR light output device comprising:
providing a multi-function IR light output device having two or more user selectable operating function states;
receiving at the multifunction IR light output device a user selected operating function state;
selectively adjusting a power level of an IR light source output responsive to the user selected operating function state.

20. The method of claim 19, wherein the two or more user selectable operating function states are selected from one of the following group: a pairing state, a receiver device selection state, a facing/no facing presence detection state, and a remote function control state.

21. A method for selecting a desired IR receiver from among several potential IR receivers comprising:
outputting a first IR function request signal from an IR source device;
receiving notification from two or more IR receivers that the IR function request signal was detected by the two or more IR receivers;
outputting a second IR function request signal from the source device having a selectively decreased power level from the first IR function request signal; and
receiving notification from a single IR receiver that the second IR function request signal was detected by the single IR receiver.

22. The method of claim 21, further comprising receiving a repositioning of the IR source device towards the desired IR receiver prior to outputting a second IR function request signal from the source device having a selectively decreased power level from the first IR function request signal.

23. The method of claim 21, wherein receiving notification from two or more IR receivers that the IR function request signal was detected by the two or more IR receivers comprising receiving notification on a communications backchannel from the two or more IR receivers to the IR source device.
